(19) United States
(12) Patent Application Publication
(10) Pub. No.: US 2006/0259985 A1
(43) Pub. Date: Nov. 16, 2006

(54) Display system and video signal output apparatus and method of controlling the display system

(76) Inventors: Yun-ju Hong, Suwon-si (KR); Young-chan Kim, Uiwang-si (KR)

Correspondence Address: STANZIONE & KIM, LLP, 919 18TH STREET, N.W., SUITE 440, WASHINGTON, DC, 20006, US

(21) Appl. No.: 11/402,910

(22) Filed: Apr. 13, 2006

(30) Foreign Application Priority Data
May 11, 2005 (KR) 2005-0039315

(51) Int. Cl. G06F 17/30

(52) U.S. Cl. 726/30

(57) ABSTRACT

A display system includes a video signal output apparatus that includes a user input unit, a comparison authentication key storage unit to store a predetermined comparison authentication key, and a video signal controller to renew the comparison authentication key on the basis of a renewal signal when the renewal signal for the comparison authentication key is input through the user input unit, and a display apparatus that includes a display, a display interface to receive a video signal from the video signal output apparatus, a reference authentication key storage unit to store a predetermined reference authentication key, and a display controller to control a display state of a picture displayed on the display according to whether the comparison authentication key received from the video signal output apparatus is identical with the reference authentication key.

### CROSS-REFERENCE TO RELATED APPLICATIONS

This application claims the benefit of Korean Patent Application No. 2005-0039315, filed May 11, 2005, in the Korean Intellectual Property Office, the entire contents of which are incorporated herein by reference.

### BACKGROUND OF THE INVENTION

1. Field of the Invention

The present general inventive concept relates to a display system, a video signal output apparatus to control the display system, and a method of controlling the display system, and more particularly, to a display system, a video signal output apparatus, and a method of controlling the display system, so as to improve a method of authenticating the video signal output apparatus.

2. Description of the Related Art

A cathode ray tube (CRT) and a flat panel display (FPD) are widely used types of display apparatuses. The FPD can use a liquid crystal display (LCD) panel and a plasma display panel (PDP) as a display panel to display a picture thereon. Further, there has been development of various other types of display apparatuses such as an electroluminescent (EL) display and a digital light processing (DLP) display.

As new display apparatuses are constantly being developed, the display apparatuses have a value that may increase the likelihood of theft.

In the conventional display apparatus, when a stolen display apparatus is connected to an incompatible video signal output apparatus, the display apparatus displays a picture based on a video signal from the video signal output apparatus without any authentication.

### SUMMARY OF THE INVENTION

The present general inventive concept provides a display system, a video signal output apparatus to control the display system, and a method of controlling the display system, which displays a picture based on a video signal from the video signal output apparatus by authenticating a comparison authentication key stored in the video signal output apparatus, and which allows a user to renew the comparison authentication key.

Additional aspects and/or advantages of the present general inventive concept will be set forth in part in the description which follows and, in part, will be obvious from the description, or may be learned by practice of the present general inventive concept.

The foregoing and/or other aspects of the present general inventive concept may be achieved by providing a display system comprising a video signal output apparatus comprising a user input unit, a comparison authentication key storage unit to store a predetermined comparison authentication key, and a video signal controller to renew the comparison authentication key on the basis of a renewal signal input through the user input unit, and a display apparatus including a display, a display interface to receive a video signal from the video signal output apparatus, a reference authentication key storage unit to store a predetermined reference authentication key, and a display controller to control a display state of a picture corresponding to the video signal to be displayed on the display according to a determination of whether the comparison authentication key received from the video signal output apparatus is identical to the reference authentication key.

The picture may comprise a normal picture and a modified picture and the display controller may display the normal picture on the display based on the video signal output from the video signal output apparatus when the comparison authentication key is identical with the reference authentication key, and the display controller alternatively displays the modified picture different from the normal picture when the comparison authentication key is different from the reference authentication key.

The display controller may display the modified picture obtained by changing at least one component of red, green and blue (RGB) data of the video signal received through the display interface when the comparison authentication key is different from the reference authentication key.

The display controller may display a portion of the normal picture corresponding to the video signal received through the display interface as the modified picture when the comparison authentication key is different from the reference authentication key.

The display controller may display the modified picture obtained by changing a size of the normal picture corresponding to the video signal when the comparison authentication key is different from the reference authentication key.

The display controller may display a monochrome picture as the modified picture when the comparison authentication key is different from the reference authentication key.

The display controller may display a message that informs the user that the comparison authentication key is different from the reference authentication key, as the modified picture, when the comparison authentication key is different from the reference authentication key.

The foregoing and/or other aspects of the present general inventive concept may also be achieved by providing a video signal output apparatus having a user input unit, including a comparison authentication key storage unit to store a predetermined comparison authentication key, a video signal interface, and a video signal controller to control the video signal interface to output the comparison authentication key, and renew the comparison authentication key on the basis of a renewal signal when the renewal signal is input through the user input unit.

The foregoing and/or other aspects of the present general inventive concept may also be achieved by providing a method of controlling a display system including receiving a comparison authentication key from a video signal output apparatus, adjusting a display state of a picture displayed on a display apparatus according to whether the comparison authentication key is identical with a reference authentication key, and renewing the comparison authentication key on the basis of a renewal signal when the renewal signal is input through a user input unit.

The controlling of the display state of the picture may include displaying a normal picture based on the video signal output from the video signal output apparatus when the comparison authentication key is identical with the reference authentication key, and displaying a modified picture different from the normal picture when the comparison authentication key is different from the reference authentication key.

The method may further include displaying a message informing a user that the comparison authentication key is different from the reference authentication key when the comparison authentication key is different from the reference authentication key.

The displaying of the modified picture may include displaying the modified picture obtained by changing at least one component of RGB data of the video signal output from the video signal output apparatus.

The displaying of the modified picture may include displaying a portion of the normal picture corresponding to the video signal output from the video signal output apparatus as the modified picture.

The displaying of the modified picture may include displaying the modified picture obtained by changing a size of the normal picture corresponding to the video signal.

The displaying of the modified picture may include displaying a monochrome picture as the modified picture.

The foregoing and/or other aspects of the present general inventive concept may also be achieved by providing a display apparatus usable with a display system comprising a display, a display interface to receive a video signal and a comparison authentication key from an external device, a reference authentication key storage unit to store a reference authentication key, and a display controller to determine whether the reference authentication key is identical to the comparison authentication key, and to generate a picture corresponding to the video signal to be displayed on the display according to the determination of whether the reference authentication key is identical to the comparison authentication key.

The foregoing and/or other aspects of the present general inventive concept may also be achieved by providing a method comprising receiving a video signal and a comparison authentication key from an external device, determining whether the comparison authentication key is identical to a stored reference authentication key, and generating a picture corresponding to the video signal to be displayed according to the determination of whether the reference authentication key is identical to the comparison authentication key.

The comparison authentication key may comprise first and second comparison keys, and the display interface may receive the first and second comparison keys and may determine whether the reference authentication key is identical to one of the first and second comparison keys. When the reference authentication key comprises the first and second reference keys, the display interface may determine whether one of the first and second reference keys is identical to the comparison authentication key.

The display controller may change the reference authentication key to a second reference authentication key, the reference authentication key storage unit may store the second reference authentication key, and the display controller may determine whether the second reference authentication key is identical to the comparison authentication key.

The foregoing and/or other aspects of the present general inventive concept may also be achieved by providing a method of displaying a picture, the method comprising receiving a video signal and a comparison authentication key from an external device, determining whether the comparison authentication key is identical to a stored reference authentication key, and generating a picture corresponding to the video signal to be displayed according to the determination of whether the reference authentication key is identical to the comparison authentication key.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a display system according to an embodiment of the present general inventive concept; and

FIG. 2 is a flowchart of a display system according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

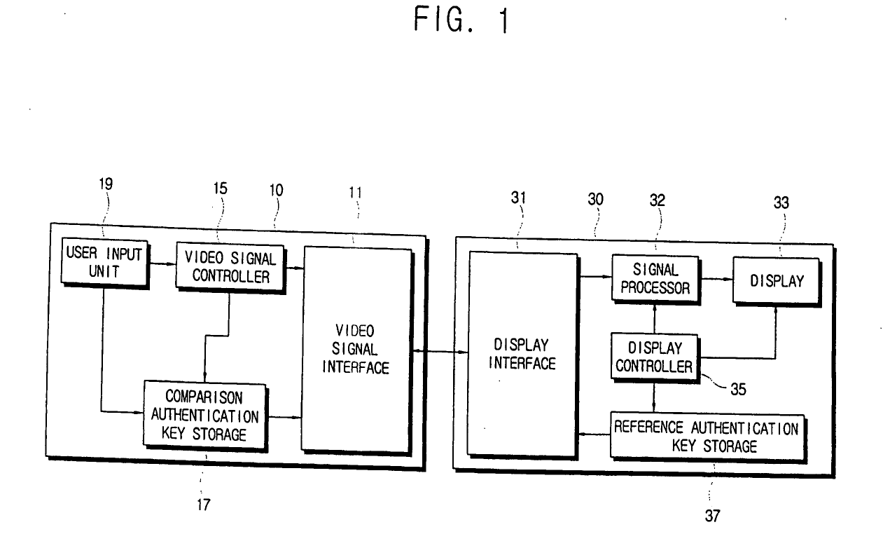

As illustrated in FIG. 1, a display system according to an embodiment of the present general inventive concept includes a display apparatus 30 to display a picture thereon, and a video signal output apparatus 10 to output a video signal to the display apparatus 30.

The video signal output apparatus 10 includes a comparison authentication key storage unit 17 to store a comparison authentication key, a video signal interface 11 to output the comparison authentication key and the video signal, a video signal controller 15 to control the comparison authentication key storage unit 17 and the video signal interface 11, and a user input unit 19 to allow a user to perform certain operations. Here, a computer is described as the video signal output apparatus 10 by way of example, but not should not be limited thereto. The video signal output apparatus may include various apparatuses to output the video signal.

The display apparatus 30 includes a display 33, a reference authentication key storage unit 37, a display interface 31 to interactively communicate with the video signal output apparatus 10, a signal processor 32 to process the video signal received through the display interface 31 to be displayed on the display 33, and a display controller 35 to control the display 33, the reference authentication key storage unit 37, the display interface 31, and the signal processor 32.

In the video signal output apparatus 10 according to the present embodiment, the video signal interface 11 interactively communicates with the display interface 31 of the display apparatus 30. For example, the video signal controller 15 outputs the video signal and the comparison authentication key to the display apparatus 30 through the video signal interface 11. The comparison authentication key can be outputted to the display apparatus 30 when the display apparatus 30 is turned on, or when the video signal output apparatus 10 is turned on according to a user selection.

Here, the video signal output from the video signal output apparatus 10 includes red (R), green (G) and blue (B) color image signals, and horizontal (H) and vertical (V) synchronous signals. However, other types of signals may also be output from the video signal output apparatus 10.

According to the present embodiment, the video signal interface 11 communicates with the display interface 31 using a display data channel (DDC) interface. A display data channel command interface (DDC-CI) may be used as the DDC interface.

Alternatively, the video signal interface may include various different types of interfaces provided they can communicate with the display interface 31. For example, when a computer is used as the video signal output apparatus 10, the video signal interface 11 may include a D-subminature (D-Sub) interface and a digital visual interface (DVI).

Further, when the video signal output apparatus 10 is the computer, the video signal interface 11 can include a graphic card that is capable of interactively communicating with the display apparatus 30 to output the video signal to the display apparatus 30.

The comparison authentication key storage unit 17 stores the comparison authentication key to determine whether the display apparatus 30 is connected to and used compatibly with the video signal output apparatus 10. The comparison authentication key storage unit 17 includes a memory (not shown), which may be, for example, an electrically erasable programmable read-only memory (EEPROM) and/or other various readable and writable storages such as a flash memory.

The video signal controller 15 of the video signal output apparatus 10 controls the video signal interface 11 and the comparison authentication key storage unit 17. For example, when the display apparatus 30 is turned on, the video signal controller 15 controls the operation of the comparison authentication key stored in the comparison authentication key storage unit 17 to be output through the video signal interface 11.

The user input unit 19 allows a user to input or select a predetermined operation, and includes a plurality of input keys and/or buttons. The way that a user input is received by the user input unit 19 may vary provided the user can select a desired operation. Through the user input unit 19, the user can store and change the comparison authentication key stored in the comparison authentication key storage unit 17 of the video signal output apparatus 10. For example, in a case that a user knows the comparison authentication key corresponding to the display apparatus 30, the user can store the comparison authentication key in the video signal output apparatus 10 through the user input unit 19, and can operate the video signal output apparatus 10 along with the display apparatus 30. Here, the user input unit 19 can include. various different types of input devices, such as a keyboard, a mouse, a touch screen, etc., so that a user can input a predetermined operation therethrough. Further, when the video signal controller 15 receives an output signal from the user input unit 19 corresponding to the comparison authentication key, the video signal controller 15 can control the video signal output apparatus 10 to output the comparison authentication key to the display apparatus 30.

As described above, the display interface 31 interactively communicates with the video signal interface 11. Therefore, the display apparatus 30 can receive the video signal and the comparison authentication key from the video signal output apparatus 10 through the display interface 31.

The signal processor 32 may include various different configurations based on the type of format of the video signal received by the display interface 31. For example, the signal processor 32 may include one or more components, for example, a scaler to scale the video signal to adjust a vertical frequency, a resolution, an aspect ratio, etc., suitable to the output specifications of the display 33, a transition minimized differential signaling (TMDS) receiver to convert the input video signal into a digital red, green and blue (RGB) signal that can be processed by the scaler based on the format of the input video signal, an analog/digital (A/D) converter, a video decoder, and a tuner.

The display 33 according to the present embodiment of the present general inventive concept can include one or more of various different types of display modules. For example, a digital light processing (DLP), a liquid crystal display (LCD), a plasma display panel (PDP), or the like can be applied to the display 33.

According to the present embodiment, the reference authentication key storage unit 37 stores a reference authentication key therein. Here, one or more reference authentication keys can be stored in the reference authentication key storage unit 37 and used to authenticate one or more corresponding video signal output apparatuses 10. In more detail, the reference authentication keys are stored in a tabular format, thereby providing a reference table to authenticate all of the video signal output apparatuses 10 that have the comparison authentication keys corresponding to the one or more stored reference authentication keys.

The display controller 35 controls the signal processor 32 and the display 33 to adjust a display state of a picture displayed on the display 33. When the display controller 35 receives the comparison authentication key from the video signal output apparatus 10, the display controller 35 compares the received comparison authentication key with the reference authentication key stored in the reference authentication key storage unit 37.

When the comparison authentication key is identical to the reference authentication key, the display controller 35 controls the signal processor 32 to process the video signal output from the video signal output apparatus 10 to display a normal picture on the display 33 based on the video signal output from the video signal output apparatus 10.

On the other hand, when the comparison authentication key is not identical to the reference authentication key, the display controller 35 controls the signal processor 32 to convert the video signal output from the video signal output apparatus 10 to a modified picture. Then, the display controller 35 controls the display 33 to display the picture based on the video signal converted by the signal processor 32. That is, the normal picture based on the video signal is changed in color, resolution, size, etc., into the modified picture and then displayed on the display 33.

In one example, the display controller 35 can control the signal processor 32 to modify at least one component of RGB data of the video signal output from the video signal output apparatus 10. In more detail, the signal processor 32 may process the RGB data by filtering at least one component of the RGB data, or modifying at least one component of the RGB data. Therefore, the display 33 will display the picture of which at least one component of the RGB data is filtered or modified.

Further, the display controller 35 can control the signal processor 32 to modify a portion of the video signal output from the video signal output apparatus 10. In this case, the display 33 may display only a portion of the normal picture, (i.e., only a center portion of the normal picture). However, the modifying of a portion of the video signal may include limiting the portion of the video signal displayed to other portions of the normal picture (e.g., a left, right, upper or bottom portion). Alternatively, the display controller 35 may control the display 33 to display the picture based on a portion of the video signal. For example, in a case that the display 33 is an LCD, the display controller 35 can turn off a backlight of the LCD.

Also, the display controller 35 can control the signal processor 32 to modify a size of the picture based on the video signal output from the video signal output apparatus 10. Therefore, the display 33 may display an enlarged (e.g., by a factor of two or four) or reduced sized picture (e.g., by a one half or one fourth).

In addition to the various different types of aforementioned modifications to the picture, the display controller 35 can control the signal processor 32 not to process the video signal, or control the display 33 to display a monochrome picture, which may include a black picture and/or a white picture, and other combinations of the monochrome picture. In this case, the black picture provides no picture, thus the display 33 will not display any picture.

Further, when the display apparatus 30 determines that the comparison authentication key is not identical to the reference authentication key, the display apparatus 30 or the video signal output apparatus 10 may control the display 33 to display a message that the authentication failed.

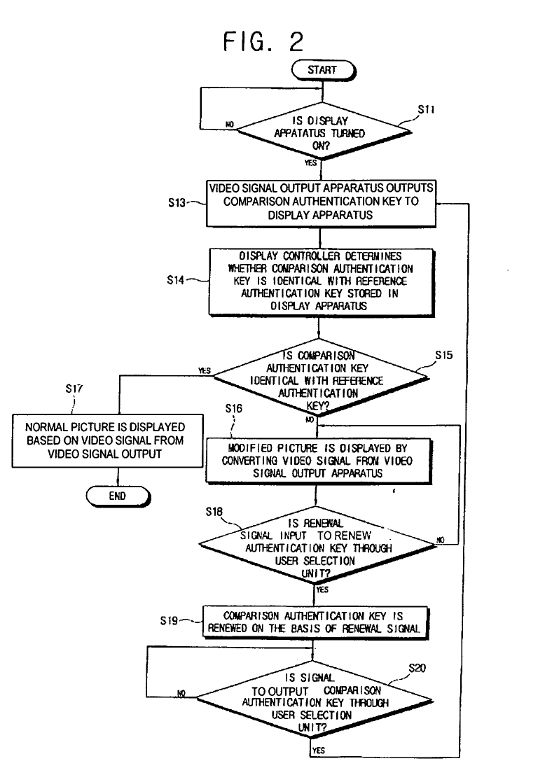

FIG. 2 is a control flowchart of a display system according to an embodiment of the present general inventive concept.

In the display system illustrated in FIGS. 1 and 2, once the display apparatus 30 is turned on at operation S11, the video signal output apparatus 10 can then output the comparison authentication key to the display apparatus 30 at operation S13.

Then, at operation S14, the display controller 35 determines whether the received comparison authentication key is identical with the reference authentication key stored in the reference authentication key storage unit 37, thereby controlling the display state of a the picture displayed on the display 33. That is, when the display controller 35 determines that the reference authentication key is identical with the comparison authentication key at operation S15, the display controller 35 controls the display 33 to display the normal picture based on the video signal output from the video signal output apparatus 10 at operation S17.

On the other hand, when the display controller 35 determines that the reference authentication key is not identical with the comparison authentication key at operation S15, the display controller 35 displays the modified picture on the display 33 by converting the video signal output from the video signal output apparatus 10 at operation S16. Here, the modified picture indicates a picture that is obtained by adjusting the video signal so as to change the display states of the normal picture, such as color, resolution, size, and the like.

Further, when the display controller 35 determines that the reference authentication key is not identical with the comparison authentication key at operation S15, the display controller 35 may control the display 33 to display the modified picture and/or a message that the authentication has failed.

The comparison authentication key can be renewed through the user input unit 19. When the video signal controller 15 receives a renewal signal to renew the comparison authentication key through the user input unit 19 at operation S18, the video signal controller 15 renews the comparison authentication key stored in the comparison authentication key storage unit 17 on the basis of the received renewal signal at operation S19.

When the video signal controller 15 receives the output signal of the user input unit 19, which is provided to output the comparison authentication key to the display apparatus 30, at operation S20, the video controller 15 outputs the comparison authentication key again at the operation S13. Then, a determination is made whether the comparison authentication key and the reference authentication key are identical with each other or not.

In the foregoing example, the modified picture is obtained by modifying the color, the size, and/or other attributes of the normal picture, but should not be limited thereto. The normal picture is expected to be displayed on the display 33 if the comparison authentication key and the reference authentication key are identical. However, if they are not identical, the normal picture will not be displayed without some modification thereto, and/or a message or indicator informing the user that the authentication has failed.

Accordingly, the display apparatus 30 according to an embodiment of the present general inventive concept authenticates the video signal output apparatus 10, and displays the normal picture on the basis of the video signal output from only the video signal output apparatus 10 that is authenticated, thereby preventing an anonymous user from using the display apparatus 30. For example, when an anonymous user relocates the display apparatus 30 to another video signal output apparatus 10 (i.e. a computer not authenticated by the display apparatus 30).

As described above, the present general inventive concept provides a display system, a video signal output apparatus, and a method of controlling the display system, which authenticates the video signal output apparatus and normally displays a picture on the basis of a video signal output from the authenticated video signal output apparatus thereby preventing an anonymous user from using the display apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display system comprising:
a video signal output apparatus comprising:
a user input unit,
a comparison authentication key storage unit to store a predetermined comparison authentication key, and
a video signal controller to renew the comparison authentication key on the basis of a renewal signal input through the user input unit; and
a display apparatus comprising:
a display,
a display interface to receive a video signal from the video signal output apparatus,
a reference authentication key storage unit to store a predetermined reference authentication key, and
a display controller to control a display state of a picture corresponding to the video signal to be displayed on the display according to a determination of whether the comparison authentication key received from the video signal output apparatus is identical to the reference authentication key.

2. The display system according to claim 1, wherein:
the picture comprises a normal picture and a modified picture;
the display controller displays the normal picture based on the video signal output from the video signal output apparatus when the comparison authentication key is identical with the reference authentication key; and the display controller alternatively displays the modified picture different from the normal picture when the comparison authentication key is different from the reference authentication key.

3. The display system according to claim 2, wherein the display controller displays the modified picture obtained by changing at least one component of red, green and blue (RGB) data of the video signal received through the display interface when the comparison authentication key is different from the reference authentication key.

4. The display system according to claim 2, wherein the display controller displays a portion of the normal picture corresponding to the video signal received through the display interface as the modified picture when the comparison authentication key is different from the reference authentication key.

5. The display system according to claim 2, wherein the display controller displays the modified picture obtained by changing a size of the normal picture corresponding to the video signal when the comparison authentication key is different from the reference authentication key.

6. The display system according to claim 2, wherein the display controller displays a monochrome picture as the modified picture when the comparison authentication key is different from the reference authentication key.

7. The display system according to claim 2, wherein the display controller displays a message that informs a user that the comparison authentication key is different from the reference authentication key as the modified picture when the comparison authentication key is different from the reference authentication key.

8. A video signal output apparatus having a user input unit, comprising:
a comparison authentication key storage unit to store a predetermined comparison authentication key;
a video signal interface; and
a video signal controller to control the video signal interface to output the comparison authentication key, and renew the comparison authentication key on the basis of a renewal signal when the renewal signal is input through the user input unit.

9. A method of controlling a display system, the method comprising:
receiving a comparison authentication key from a video signal output apparatus;
adjusting a display state of a picture displayed on a display apparatus according to whether the comparison authentication key is identical to a reference authentication key; and
renewing the comparison authentication key on the basis of a renewal signal when the renewal signal is input through a user input unit.

10. The method according to claim 9, wherein the adjusting of the display state of the picture comprises:
displaying a normal picture based on the video signal output from the video signal output apparatus when the comparison authentication key is identical with the reference authentication key; and
displaying a modified picture different from the normal picture when the comparison authentication key is different from the reference authentication key.

11. The method according to claim 10, further comprising:
displaying a message informing a user that the comparison authentication key is different from the reference authentication key when the comparison authentication key is different from the reference authentication key.

12. The method according to claim 10, wherein the displaying of the modified picture comprises:
displaying the modified picture obtained by changing at least one component of RGB data of the video signal output from the video signal output apparatus.

13. The method according to claim 10, wherein the displaying of the modified picture comprises:
displaying a portion of the normal picture corresponding to the video signal output from the video signal output apparatus as the modified picture.

14. The method according to claim 10, wherein the displaying of the modified picture comprises:
displaying the modified picture obtained by changing a size of the normal picture corresponding to the video signal.

15. The method according to claim 10, wherein the displaying of the modified picture comprises:
displaying a monochrome picture as the modified picture.

16. A display system, comprising:
a display;
a display interface to receive a video signal and a comparison authentication key from an external device;
a reference authentication key storage unit to store a reference authentication key; and
a display controller to determine whether the reference authentication key is identical to the comparison authentication key, and to generate a picture corresponding to the video signal to be displayed on the display according to the determination of whether the reference authentication key is identical to the comparison authentication key.

17. The display system of claim 16, wherein the display interface receives the comparison authentication key from the external device when the display apparatus is turned on.

18. The display system of claim 16, wherein the display interface receives the comparison authentication key from the external device when the external device is turned on.

19. The display system of claim 16, wherein the picture comprises a first picture having a first characteristic and a second picture having a second characteristic, and the display controller generates one of the first picture and the second picture according to the determination.

20. The display system of claim 16, wherein the display controller controls a display state of the picture to display one of a normal picture corresponding to the video signal and a modified picture different from the normal picture.

21. The display system of claim 20, wherein the display state of the picture corresponds to at least one of a size, a color, a component, and a message.
